(19) United States
(12) Patent Application Publication
(10) Pub. No.: US 2014/0362128 A1
(43) Pub. Date: Dec. 11, 2014

(54) METHOD AND DEVICE FOR DISPLAYING PIXEL ARRANGEMENT AND OLED DISPLAY THEREOF

(71) Applicant: EverDisplay Optronics (Shanghai) Limited, Shanghai (CN)

(72) Inventor: Chuwan HUANG, Shanghai (CN)

(73) Assignee: EverDisplay Optronics (Shanghai) Limited, Shanghai (CN)

(21) Appl. No.: 14/171,535

(22) Filed: Feb. 3, 2014

(30) Foreign Application Priority Data
Jun. 9, 2013 (CN) 201310231951.5

(51) Int. Cl. G09G 3/32

(52) U.S. Cl. CPC G09G 3/3208
USPC 345/690; 345/83

(57) ABSTRACT

A method for displaying a pixel arrangement has the following steps: step S1: dividing a time taken for displaying a pixel into a first period of time, a darkening period of time and a second period of time; step S2: determining respectively intensities of a first sub pixel of a first pixel and a second sub pixel of a second pixel adjacent to the first pixel in the pixel arrangement during the first period of time, and determining the intensities of the first sub pixel and the second sub pixel during the second period of time such that a virtual pixel is virtualized out between the first pixel and the second pixel; and step S3: displaying the first pixel and the second pixel respectively in accordance with the intensities determined in step S2 during the first period of time and the second period of time.

### CROSS REFERENCE TO RELATED APPLICATION

The present disclosure claims priority under 35 U.S.C. §119 to Chinese Patent Application No. 201310231951.5, filed on Jun. 9, 2013, the entire content of which is incorporated herein by reference.

### TECHNICAL FIELD

The present disclosure relates to a field of OLED display technology, and particularly to a method for displaying a pixel arrangement and a device for displaying a pixel arrangement and an OLED display having the device for displaying the pixel arrangement of the present disclosure.

### BACKGROUND

Both the luminous efficiency and the life cycle of an organic light emitting diode (hereinafter referred to as OLED) are factors that need to be seriously considered in products design, which directly influence the aperture proportion of a pixel on a display screen and the adjustment of driving currents. If power consumption can be efficiently decreased without influencing the display quality of an OLED display and the life cycle of an OLED material, it will be greatly beneficial to products.

A method for displaying a pixel arrangement and a device thereof in the prior art is known, and the display method is shown in FIG. 1. FIG. 1 is a diagram showing a pixel region of a display screen, which has N×M pixels, and if a certain region needs to be luminous for a period of time, pixels in the region may turn on and last for the period of time. FIG. 2 is a diagram showing a usual time and intensity required for a desired image to be displayed. However, the actual time and intensity for a pixel to be displayed is shown in FIG. 3, which rather differs from FIG. 2, thereby influencing the display quality of an OLED display. It needs to be explained that, in the drawings of the present disclosure, T on the horizontal ordinate refers to time, and the vertical ordinate refers to luminous intensity.

Thus, people consider efficiently decreasing power consumption without influencing the display quality and the life cycle of an OLED material, and the following method is proposed.

With regard to a time and intensity required for a desired image to be displayed the same as FIG. 2, by utilizing visual persistence and an enough short reaction speed of an OLED, the time T originally required for displaying is divided into a lighting time A1+A2+ . . . and a darkening time B1+B2+ . . . , as shown in FIG. 4. This method may make the perception of human eyes with respect to displayed contents unchanged, but the actual lighting time is reduced, thus power consumption may be decreased.

Though the above method can attain effects of reducing the lighting time and decreasing power consumption, the display quality is still not good, and the resolution of a display device and display images thereof can not be increased.

Thus, there needs a method for displaying a pixel arrangement and a device thereof which are capable of increasing the resolution while decreasing power consumption and increasing the service cycle of products.

### SUMMARY

Aiming at problems exiting in the prior art, an object of the present disclosure is to provide a method for displaying a pixel arrangement which is capable of increasing the resolution while decreasing power consumption and increasing the service cycle of products.

Another object of the present disclosure is to provide a device for displaying a pixel arrangement which is capable of increasing the resolution while decreasing power consumption and increasing the service cycle of products.

Yet another object of the present disclosure is to provide an OLED display having the device for displaying the pixel arrangement of the present disclosure.

In order to achieve, in part, the above objects, technical solutions of the present disclosure are given as follows:

A method for displaying a pixel arrangement, wherein the method comprises: step S1: dividing a time taken for displaying a pixel into a first period of time, a darkening period of time and a second period of time, wherein the first period of time and the second period of time are for displaying the pixel, the darkening period of time during which the pixel is not displayed is interposed between the first period of time and the second period of time, and the darkening period of time is less than a preset time; step S2: determining respectively intensities of a first sub pixel of a first pixel and a second sub pixel of a second pixel adjacent to the first pixel in the pixel arrangement during the first period of time, and determining the intensities of the first sub pixel and the second sub pixel during the second period of time such that a virtual pixel is virtualized out between the first pixel and the second pixel; and step S3: displaying the first pixel and the second pixel respectively in accordance with the intensities determined in the step S2 during the first period of time and the second period of time.

A device for displaying a pixel arrangement, comprising: a dividing module, configured to divide a time taken for displaying a pixel into a first period of time, a darkening period of time and a second period of time, wherein the first period of time and the second period of time are for displaying the pixel, the darkening period of time during which the pixel is not displayed is interposed between the first period of time and the second period of time, and the darkening period of time is less than a preset time; a color synthesizing module, configured to determine respectively intensities of a first sub pixel of a first pixel and a second sub pixel of a second pixel adjacent to the first pixel in the pixel arrangement during the first period of time, and determine the intensities of the first sub pixel and the second sub pixel during the second period of time such that a virtual pixel is virtualized out between the first pixel and the second pixel; and a displaying module, configured to display the first pixel and the second pixel respectively in accordance with the determined intensities during the first period of time and the second period of time.

An OLED display of the present disclosure having the device for displaying the pixel arrangement of the present disclosure.

Advantageous effects of the present disclosure, in part, lie in: through the method for displaying a pixel arrangement, the device for displaying a pixel arrangement and the OLED display according to the embodiments in the present disclosure, the lighting time of a pixel is divided into several periods of time, and if only the darkening time is not more than the time of visual persistence, and the pixel is schemed with an adjacent pixel using a different algorithm for time series, i.e., dividing its time series, another pixel may be virtualized out among the respective pixels, thereby, in part, the resolution of a display device and display images thereof may be increased, for example the resolution may be increased by 50%, and the display quality is increased; meanwhile, power consumption may be decreased efficiently, such that it will be greatly beneficial to OLED display products.

### BRIEF DESCRIPTION OF THE DRAWINGS

FIG. 1 is a schematic diagram showing a displaying of a certain region of a common OLED display screen.

FIG. 2 is a diagram showing a time and intensity required for a desired image to be displayed in the region shown in FIG. 1.

FIG. 3 is a diagram showing the actual time and intensity for a pixel to be displayed in the region shown in FIG. 1.

FIG. 4 is a diagram showing the actual time and intensity for a pixel to be displayed after the time originally required for displaying is divided into a lighting time and a darkening time.

FIG. 5 is a schematic diagram showing a first type of pixel arrangement utilized by a method for displaying a pixel arrangement of embodiments in the present disclosure.

FIG. 6 is a schematic diagram showing a time and intensity for pixels of a pixel arrangement shown in FIG. 5 to be displayed in accordance with a method in the prior art.

FIG. 7 is a schematic diagram showing a time and intensity for pixels of a pixel arrangement shown in FIG. 5 to be displayed in accordance with a method for displaying a pixel arrangement of the present disclosure.

FIG. 8 is a schematic diagram showing a second type of pixel arrangement utilized by a method for displaying a pixel arrangement of embodiments in the present disclosure.

FIG. 9 is a schematic diagram showing a time and intensity for pixels of a pixel arrangement shown in FIG. 8 to be displayed in accordance with a method in the prior art.

FIG. 10 is a schematic diagram showing a time and intensity for pixels of a pixel arrangement shown in FIG. 8 to be displayed in accordance with a method for displaying a pixel arrangement of embodiments in the present disclosure.

FIG. 11 is a block diagram showing a device for displaying a pixel arrangement of embodiments in the present disclosure.

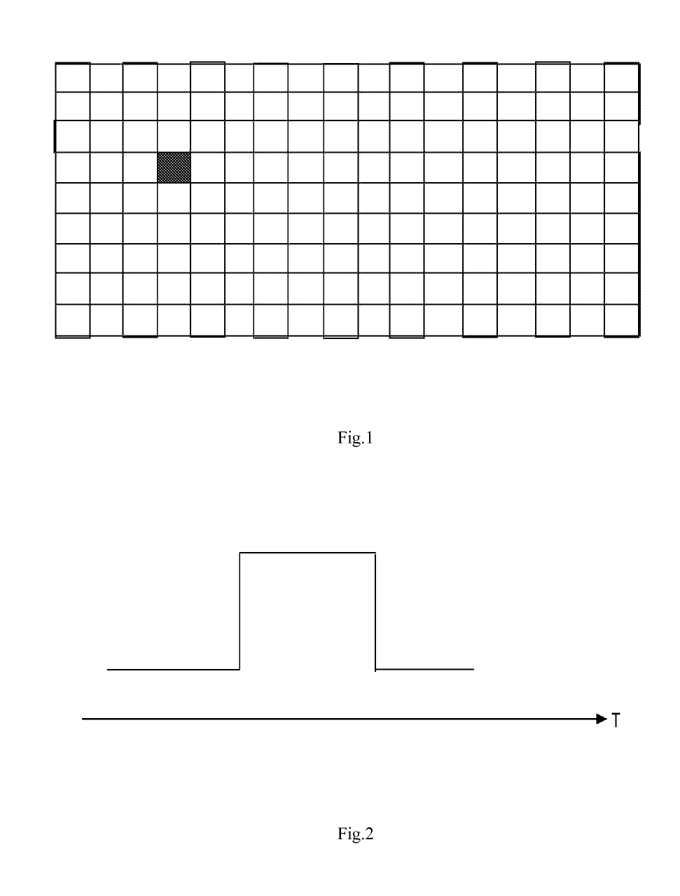

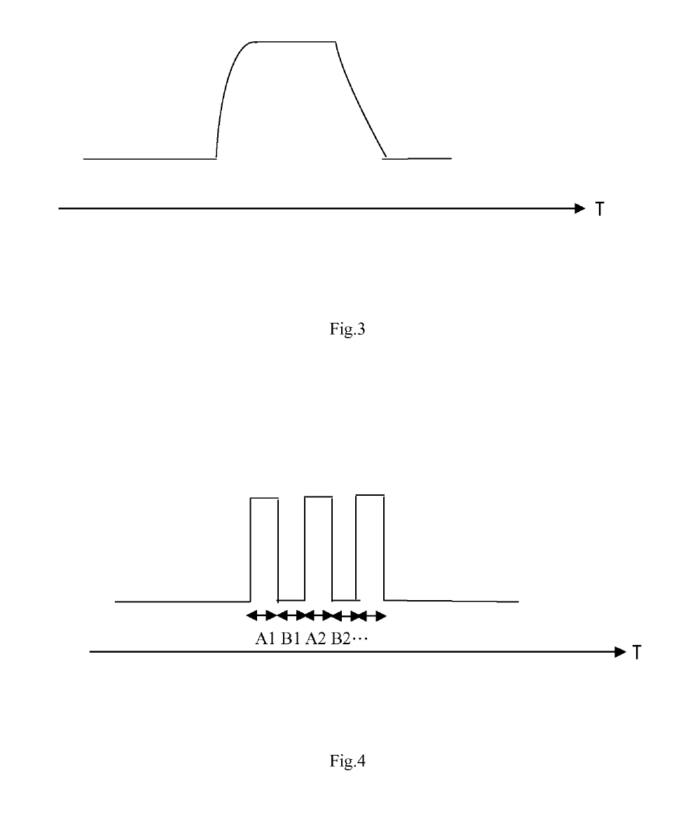

### DETAILED DESCRIPTION

Typical embodiments representing features and advantages of the present disclosure will be described in detail in the following description. It shall be understood that the present disclosure can have various changes in different embodiments without departing from the scope of the present disclosure, and the description and the drawings herein are only illustrative, and do not intend to limit the present disclosure.

A method for displaying a pixel arrangement of the embodiments in the present disclosure may be implemented by a device for displaying a pixel arrangement of the embodiments in the present disclosure, and an OLED display of the embodiments in the present disclosure has the device for displaying the pixel arrangement of the embodiments in the present disclosure.

A method for displaying a pixel arrangement of the embodiments in the present disclosure will be introduced below with respect to two different types of pixel arrangements.

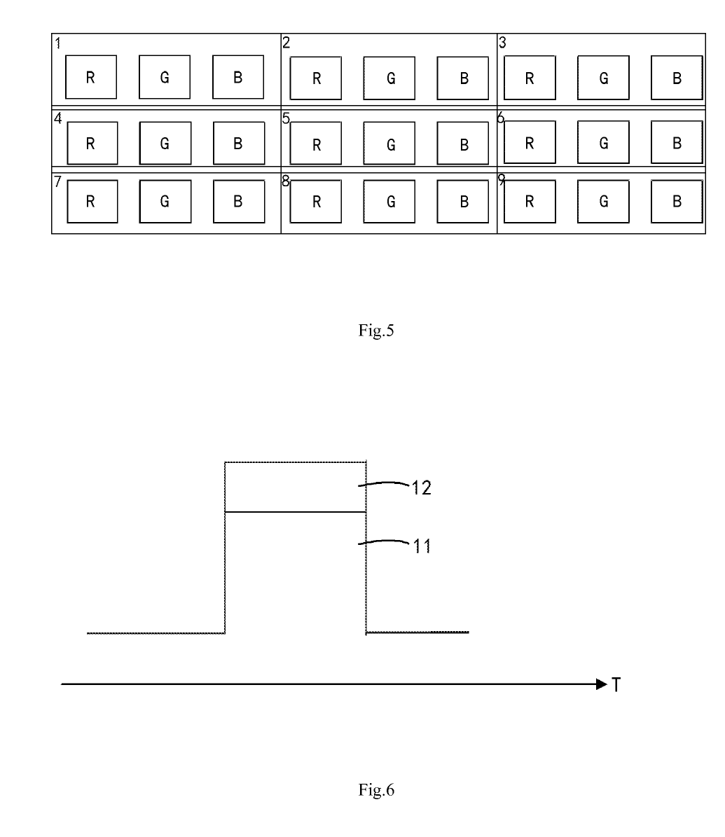

A first type of pixel arrangement is shown in FIG. 5, and it includes 9 groups of pixels 1, 2, . . . , and 9, arranged in a form of 3×3. Each group of pixels includes three sub pixels including one red sub pixel R, one green sub pixel G and one blue sub pixel B, the red sub pixel R is adjacent to the green sub pixel G, and the blue sub pixel B is adjacent to the green sub pixel G.

A pixel 1 and a pixel 2 of a pixel arrangement shown in FIG. 5 are adjacent to each other, and in accordance with a method for displaying a pixel arrangement in the prior art, as shown in FIG. 6, during a whole period of time, a color mixed by the red sub pixel R of the pixel 2 and the blue sub pixel B of the pixel 1 may be displayed, wherein an intensity 12 of the red sub pixel R of the pixel 2 and an intensity 11 of the blue sub pixel B of the pixel 1 are determined in accordance with image contents that need to be displayed.

The method for displaying the pixel arrangement of the embodiments in the present disclosure includes the following steps:

(I). A Step of Dividing a Time Series

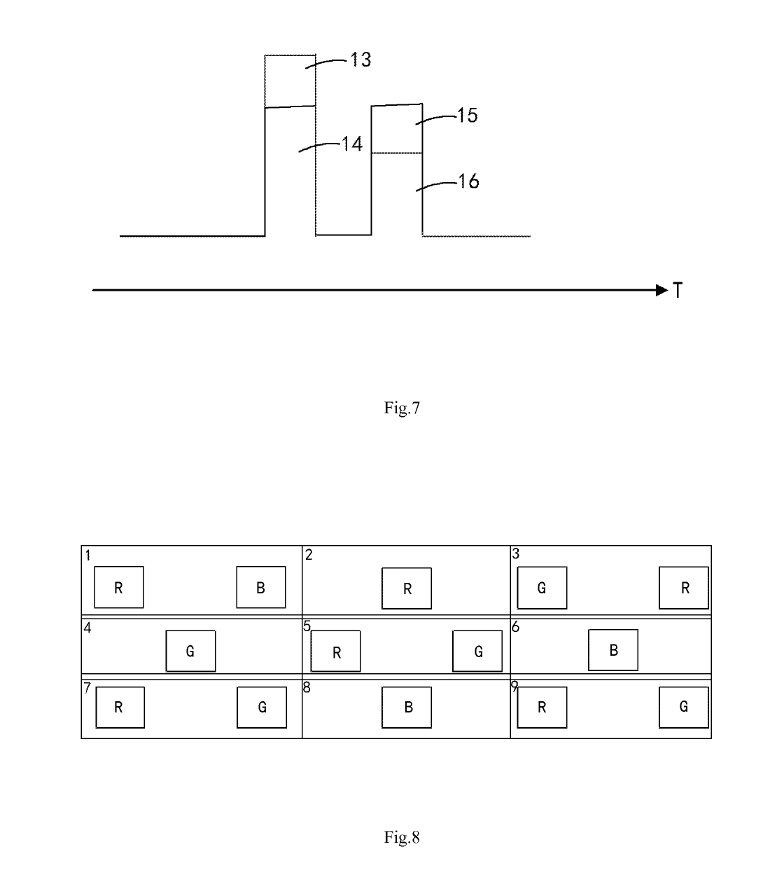

At first, a step of dividing time series is performed, namely, dividing a time taken for displaying pixels shown in FIG. 6 into a first period of time, a darkening period of time and a second period of time shown in FIG. 7, wherein the pixels are displayed during the first period of time and the second period of time, the darkening period of time during which the pixels are not displayed is interposed between the first period of time and the second period of time. In another embodiment, the above lighting times, i.e. the first period of time or the second period of time may also be divided into several periods of time, if only respective darkening times respectively interposed between the corresponding lighting times, namely, darkening periods of time is less than a preset time. The preset time may be a time of visual persistence. The time taken for displaying pixels or a pixel in the present disclosure refers to a time taken for displaying pixels or a pixel within a scanning cycle.

For example, a proportion of the first period of time to the second period of time may be 2:1, a proportion of the first period of time to the darkening period of time and to the second period of time may be for example 4:4:2, but the present disclosure is not limited thereto. Generally, it is only required that the darkening period of time is greater than the time of visual persistence.

(II). A Step of Determining an Intensity of a Virtual Pixel (i.e. a Step of Color Synthesizing)

The difference between the present method and the prior art mainly lies in that, in the second period of time, a pixel is schemed with an adjacent pixel to display a virtual pixel, thereby to achieve an object of increasing the resolution. For example, with respect to the pixel 1 and the pixel 2 of the pixel arrangement shown in FIG. 5, another pixel may be virtualized out between the pixel 1 and the pixel 2, thereby to increase the resolution.

For example in the pixel arrangement shown in FIG. 5, generally, 9 groups of R, G and B sub pixels respectively display 9 pixels. Adjacent pixels mentioned here may be adjacent in an up-down direction, and may also be adjacent in a left-right direction, or in an opposite angle direction. For example with respect to pixel 5, the rest pixels except for the pixel 5 may be pixels adjacent to the pixel 5, wherein pixels 2 and 8 are adjacent to the pixel 5 in the up-down direction, pixels 4 and 6 are adjacent to the pixel 5 in the left-right direction, and pixels 1, 3, 7 and 9 are adjacent to the pixel 5 in the opposite angle direction. By means of R, G and B sub pixels in the pixel 5 using the previously-described method for time series, i.e., dividing its time series, and R, G and B sub pixels in adjacent pixels such as pixels 1, 2, 3, 4, 6, 7, 8 and 9 using different method for time series, i.e., dividing their time series, other pixels may be virtualized out in the respective adjacent pixels.

The red sub pixel R of the pixel 2 and the blue sub pixel B of the pixel 1 are still described as an example, but the present disclosure is not intended to limit the selection of sub pixels, and as shown in FIG. 7, an intensity 13 of the red sub pixel R of the pixel 2 and an intensity 14 of the blue sub pixel B of the pixel 1 during the first period of time need to be determined, wherein the intensities 13 and 14 are respectively the same as the intensities 12 and 11 in FIG. 6.

Then, an intensity 15 of the red sub pixel R of the pixel 2 and an intensity 16 of the blue sub pixel B of the pixel 1 during the second period of time are determined. Here, the intensity 15 may be greater than the intensity 13, or may be smaller than the intensity 13, and the intensity 16 may be greater than the intensity 14, or may be smaller than the intensity 14. The intensities 15 and 16 here need to be determined in accordance with the contents that need to be displayed. For example, it needs to render a luminance of 70% of a blue color and a luminance of 30% of a red color, which are determined according to a virtual color that needs to be rendered between the pixel 1 and the pixel 2, and specifically, may be calculated according to a color equation.

The color equation is given as follows:

C=R(R)+G(G)+B(B)

Wherein C represents a color light to be synthesized; (R), (G) and (B) respectively represent unit amount of three primary colors of red, green and blue to produce a mixed color, and R, G and B are respectively amount of the three primary colors of red, green and blue required for synthesizing the mixed color to be synthesized, which is referred to as tristimulus values, and “=” represents being equivalent visually, namely, the color has been synthesized rightly.

Wherein, with regard to the unit amount of the three primary colors, in accordance with rules of the International Commission on Illumination (CIE), wavelengths of the three primary colors of red, green and blue are respectively 700 nm, 546.1 nm and 435.8 nm. In experiments of color synthesizing, when relative luminance of the three primary colors are 1.0000:4.5907:0.0601, white light having equal energy can be synthesized, therefore the CIE selects this proportion as the unit amount of the three primary colors of red, green and blue, namely (R):(G):(B)=1:1:1. Though luminance values of the three primary colors here are not equal to each other, the CIE looks the luminance value of each primary color as one unit, thus a result of equal proportion mixture of the three primary colors of red, green and blue in an additive color method of color light is white light, namely (R)+(G)+(B)=(W). The tristimulus values of a spectrum are shown in table 1:

TABLE 1

| | three stimulus values of spectrum | | |
|---|---|---|---|
| λ(nm) | r̅ (λ) | g̅ (λ) | b̅ (λ) |
| 480 | −0.04939 | 0.03914 | 0.14494 |
| 530 | −0.07101 | 0.20317 | 0.00549 |
| 700 | 0.00410 | 0.00000 | 0.00000 |

(III). A Step of Displaying

After the intensities 13, 14, 15 and 16 are determined in the above steps, the respective sub pixels are displayed respectively in accordance with the intensities 13, 14, 15 and 16 during the first period of time and the second period of time.

A second type of pixel arrangement is shown in FIG. 8, and it includes 9 groups of pixels 1, 2, . . . , and 9 arranged in a form of 3×3. Each group of pixels includes one sub pixel or two sub pixels including various combinations of a red sub pixel R, a green sub pixel G or a blue sub pixel B.

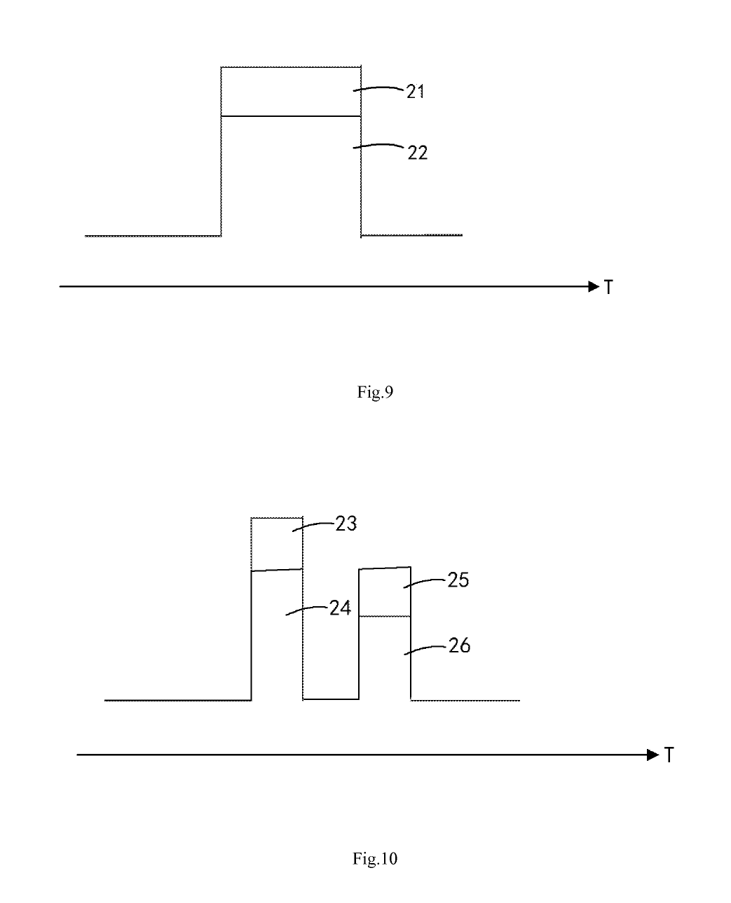

A pixel 1 and a pixel 2 of a pixel arrangement shown in FIG. 8 are adjacent to each other, and in accordance with a method for displaying a pixel arrangement in the prior art, as shown in FIG. 9, during a whole period of time, a color mixed by the red sub pixel R of the pixel 2 and the blue sub pixel B of the pixel 1 is displayed, wherein an intensity 11 of the red sub pixel R of the pixel 2 and an intensity 12 of the blue sub pixel B of the pixel 1 are determined in accordance with image contents that need to be displayed.

If pixels are displayed in accordance with the method for displaying the second type of pixel arrangement of the embodiments in the present disclosure, the method also includes a step of dividing time series, a step of determining an intensity of a virtual pixel and a step of displaying, which differs from the method for displaying the first type of pixel arrangement in a specific step of determining the intensity of the virtual pixel. The rest of the steps of the method for displaying the second type of pixel arrangement are the same as the method for displaying the first type of pixel arrangement, and the repetition is omitted herein.

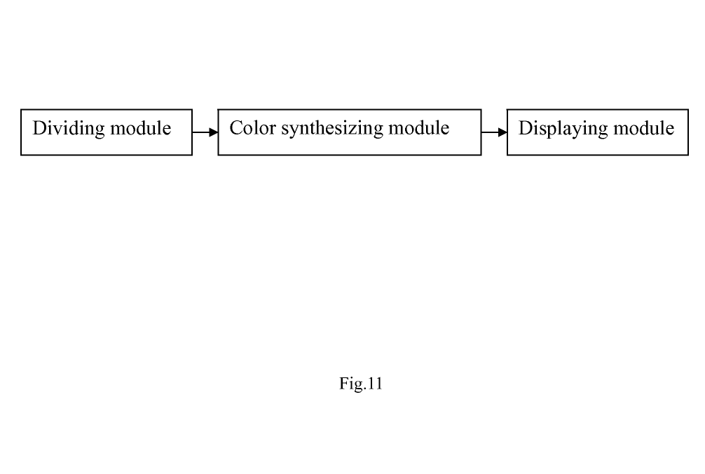

In the second type of pixel arrangement, the red sub pixel R of the pixel 2 and the blue sub pixel B of the pixel 1 are still described as an example, and as shown in FIG. 10, an intensity 23 of the red sub pixel R of the pixel 2 and an intensity 24 of the blue sub pixel B of the pixel 1 during the first period of time need to be determined, wherein the intensities 23 and 24 are respectively the same as the intensities 21 and 22 in FIG. 9.

Then, an intensity 25 of the red sub pixel R of the pixel 2 and an intensity 26 of the blue sub pixel B of the pixel 1 during the second period of time are determined. Here, the intensity 25 may be greater than the intensity 23, or may be smaller than the intensity 23, and the intensity 26 may be greater than the intensity 24, or may be smaller than the intensity 24. The intensities 25 and 26 here need to be determined in accordance with the display contents that need to be displayed, namely, they need to be determined according to a virtual color that needs to be render between the pixel 1 and the pixel 2, and specifically, may be calculated according to a color equation, which is the same as the above method, and thus is omitted here to avoid repetition.

A device for displaying a pixel arrangement of the embodiments in the present disclosure will be introduced below. As shown in FIG. 11, the device includes a dividing module, a color synthesizing module and a displaying module. The red sub pixel R of the pixel 2 and the blue sub pixel B of the pixel 1 in the first type of pixel arrangement are still described as an example to introduce the modules below.

The dividing module is configured to divide time taken for displaying a pixel into a first period of time and a second period of time for displaying the pixel, wherein a darkening period of time during which the pixel is not displayed is interposed between the first period of time and the second period of time.

The color synthesizing module is configured to respectively determine an intensity 13 of a red sub pixel R of a pixel 2 and an intensity 14 of a blue sub pixel B of a pixel 1 during the first period of time, and determine an intensity 15 of the red sub pixel R of the pixel 2 and an intensity 16 of the blue sub pixel B of the pixel 1 during the second period of time such that a virtual pixel may be virtualized out between the pixel 1 and the pixel 2.

The displaying module is configured to respectively display the respective sub pixels in accordance with the intensities 13, 14, 15 and 16 determined by the color synthesizing module, during the first period of time and the second period of time.

Through the method for displaying a pixel arrangement, the device for displaying a pixel arrangement and the OLED display according to the embodiments in the present disclosure, the lighting time of a pixel is divided into several periods of time, and if only the darkening time is not more than the time of visual persistence, and the pixel is schemed with an adjacent pixel using a different algorithm for time series, i.e., dividing its time series, another pixel may be virtualized out among the respective pixels, thereby, in part, the resolution of a display device and display images thereof may be increased, for example the resolution may be increased by 50%, and the display quality is increased; meanwhile, power consumption may be decreased efficiently, such that it will be greatly beneficial to OLED display products.

Those skilled in the art shall be noted that modifications and variations made under a situation that is not apart from the scope and spirit of the present disclosure disclosed by the appended claims of the present disclosure fall into the protection scope of the claims of the present disclosure.

What is claimed is:

1. A method for displaying a pixel arrangement comprising the steps of:
step S1: dividing a time taken for displaying a pixel into a first period of time, a darkening period of time and a second period of time, wherein the first period of time and the second period of time are for displaying the pixel, the darkening period of time during which the pixel is not displayed is interposed between the first period of time and the second period of time, and the darkening period of time is less than a preset time;
step S2: determining respectively intensities of a first sub pixel of a first pixel and a second sub pixel of a second pixel adjacent to the first pixel in the pixel arrangement during the first period of time, and determining the intensities of the first sub pixel and the second sub pixel during the second period of time such that a virtual pixel is virtualized out between the first pixel and the second pixel; and
step S3: displaying the first pixel and the second pixel respectively in accordance with the intensities determined in the step S2 during the first period of time and the second period of time.

2. The method according to claim 1, wherein a proportion of the first period of time to the second period of time is 2:1.

3. The method according to claim 2, wherein during the second period of time, a proportion of luminance of the first sub pixel to the second sub pixel is 7:3.

4. The method according to claim 1, wherein the pixel arrangement comprises 9 groups of pixels arranged in a form of 3×3, and each pixel comprises three sub pixels.

5. The method according to claim 4, wherein adjacent sub pixels comprise adjacent sub pixels in a up-down direction, in a left-right direction or in an opposite angle direction.

6. The method according to claim 1, wherein the pixel arrangement comprises 9 groups of pixels arranged in a form of 3×3, and each pixel comprises one sub pixel or two sub pixels.

7. The method according to claim 2, wherein a color equation used to determine the intensities during the second period of time is:
C=R(R)+G(G)+B(B),
Wherein C represents color light to be synthesized; (R), (G) and (B) represents unit amount of three primary colors of red, green and blue that produce a mixed color; R, G and B are respectively amount of the three primary colors of red, green and blue required for synthesizing the mixed color to be synthesized.

8. The method according to claim 2, wherein a proportion of the first period of time to the darkening period of time and to the second period of time is 2:4:2.

9. A device for displaying a pixel arrangement, comprising:
a dividing module, configured to divide a time taken for displaying a pixel into a first period of time, a darkening period of time and a second period of time, wherein the first period of time and the second period of time are for displaying the pixel, the darkening period of time during which the pixel is not displayed is interposed between the first period of time and the second period of time, and the darkening period of time is less than a preset time;
a color synthesizing module, configured to determine respectively intensities of a first sub pixel of a first pixel and a second sub pixel of a second pixel adjacent to the first pixel in the pixel arrangement during the first period of time, and determine the intensities of the first sub pixel and the second sub pixel during the second period of time such that a virtual pixel is virtualized out between the first pixel and the second pixel; and
a displaying module, configured to display the first pixel and the second pixel respectively in accordance with the determined intensities during the first period of time and the second period of time.

10. An OLED display, wherein the OLED display has the device for displaying a pixel arrangement according to claim 9.
